(19) United States
(12) Patent Application Publication
(10) Pub. No.: US 2005/0038629 A1
(43) Pub. Date: Feb. 17, 2005

(54) Pricing of enterprise information resource management systems

(76) Inventors: Ruth Amaru, Gush Etzion (IL); Rannen Meir, Jerusalem (IL); Loren D. Osbom, Herndon, VA (US); Jeffrey T. Rettinger, New Fairfield, CT (US); Justin J. Rockman, Jerusalem (IL); Zvi Schreiber, Jerusalem (IL)

Correspondence Address: James C. Scheller, Jr.;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/821,464

(22) Filed: Apr. 9, 2004

Related U.S. Application Data
(63) Continuation-in-part of application No. 10/053,045, filed on Jan. 15, 2002.
Application No. 10/053,045 is a continuation-in-part of application No. 09/904,457, filed on Jul. 6, 2001.
Application No. 09/904,457 is a continuation-in-part of application No. 09/866,101, filed on May 25, 2001.

(51) Int. Cl. G06F 7/00

(52) U.S. Cl. 702/179

(57) ABSTRACT

A method for determining the complexity of an enterprise information resource management system, the enterprise information resource management system being used to contain an ontology into which a plurality of enterprise data assets are mapped, the ontology including a plurality of model constructs, the enterprise data assets including a plurality of assets constructs, and the mappings between the data assets and the ontology including a plurality of mapping constructs, including receiving (i) a number of distinct asset constructs, denoted by C_{ASSET}, (ii) a number of distinct mapping constructs, denoted by C_{MAPPING}, and (iii) a number of distinct model constructs, denoted by C_{MODEL}, evaluating a metric of complexity, denoted by M, for an enterprise information resource management system having a capacity corresponding to C_{ASSET}, C_{MAPPING} and C_{MODEL}, according to a formula
M=ƒ(C_{ASSET}, C_{MAPPING}, C_{MODEL}, X), where ƒ is a real-valued function of three or more real-valued parameters and X denotes optional additional parameters, and using the metric M within a transaction processing system, for license of the enterprise information resource management system. A system and computer-readable storage medium are also described and claimed.

### CROSS REFERENCES TO RELATED APPLICATIONS

This application is a continuation-in-part of assignee's pending application U.S. Ser. No. 10/053,045, filed on Jan. 15, 2002, entitled “Method and System for Deriving a Transformation by Referring Schema to a Central Model,” which is a continuation-in-part of assignee's application U.S. Ser. No. 09/904,457 filed on Jul. 6, 2001, entitled “Instance Brower for Ontology,” which is a continuation-in-part of assignee's application U.S. Ser. No. 09/866,101 filed on May 25, 2001, entitled “Method and System for Collaborative Ontology Modeling.”

### FIELD OF THE INVENTION

The present invention relates to enterprise information resource management systems, and in particular to pricing of such systems.

### BACKGROUND OF THE INVENTION

Conventional enterprise software systems, such as Oracle® Enterprise Manager, developed and marketed by Oracle Corporation of Redwood Shores, CA, and SAP®, developed and marketed by SAP AG of Walldorf, Germany, are priced based on the number of “seats”—i.e., the number of users of a system within a company intranet. Thus such systems typically have small business, mid-size business and large business versions. Others are priced based on different levels of feature sets, or on the number and nature of the CPUs they are run on. Some information management systems, such as the Extract, Transform and Load (ETL) system from Informatica Corporation of Redwood City, Calif., are priced based on a number of data sources.

It is known that economic efficiency for vendors and customers of software requires that pricing of software reflect a proportion of the value created by the software, so that customers may realize a return on investment in all different configurations, and so that vendors may capture a fair portion of the value they create.

Seat-based pricing only provides a fair measure of value when the application is primarily a way of supporting user processes, so that the number of users is approximately proportional to the amount of value. Server or CPU based pricing only provides a fair measure of value when the system is processing high volumes of transactions, so that the number and power of CPUs is approximately proportional to the amount of value.

The industry requires a fair measure of value for systems such as metadata repositories, whose value lies in their ability to manage underlying information resources and other IT assets and to increase understanding of such assets and of the dependencies between them. Such systems create value relating to the number, complexity and significance of the asset, managed, the extent of the facilities provided for supporting their management, impact analysis and design support, and the resulting efficiencies, productivity, risk reduction and agility provided to the business.

### SUMMARY OF THE INVENTION

The present invention provides a novel pricing formula for enterprise information resource management systems. Specifically, the present invention introduces a “measure of the complexity” of a business' data environment, based on the number of constructs required to model the enterprises IT system structures and/or the number of constructs required to generate a central model into which the business' data assets can be mapped. Such a measure of complexity accurately reflects the needs of a business and, in turn, is used to price an enterprise information resource management system that is appropriate for the business.

There is thus provided in accordance with a preferred embodiment of the present invention a method for determining complexity of an enterprise information resource management system, the enterprise information resource management system being used to contain an ontology into which a plurality of enterprise data assets are mapped, the ontology including a plurality of model constructs, the enterprise data assets including a plurality of assets constructs, and the mappings between the data assets and the ontology including a plurality of mapping constructs, including receiving (i) a quantity of distinct asset constructs, denoted by C_{ASSET}, (ii) a quantity of distinct mapping constructs, denoted by C_{MAPPING}, and (iii) a quantity of distinct model constructs, denoted by C_{MODEL}, evaluating a metric of complexity, denoted by M, for an enterprise information resource management system having a capacity corresponding to C_{ASSET}, C_{MAPPING} and C_{MODEL}, according to a formula
M=ƒ(C_{ASSET}, C_{MAPPING}, C_{MODEL}, X),
where ƒ is a real-valued function of three or more real-valued parameters and X denotes optional additional parameters, and using the metric M within a transaction processing system, for license of the enterprise information resource management system.

There is moreover provided in accordance with a preferred embodiment of the present invention a method for determining complexity of a metadata repository including a plurality of metadata constructs, including receiving a quantity of distinct metadata constructs, denoted by C, evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters, and using the metric M within a transaction processing system, for license of the metadata repository.

There is additionally provided in accordance with a preferred embodiment of the present invention a method for determining complexity of a metadata repository including a plurality of metadata constructs, the metadata constructs being instances of meta-model constructs for meta-models of schemas for data assets, including receiving a quantity of distinct meta-model constructs, denoted by C, evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters, and using the metric M within a transaction processing system, for license of the metadata repository.

There is further provided in accordance with a preferred embodiment of the present invention a system for determining complexity of an enterprise information resource management system, the enterprise information resource management system being used to contain an ontology into which a plurality of enterprise data assets are mapped, the ontology including a plurality of model constructs, the enterprise data assets including a plurality of assets constructs, and the mappings between the data assets and the ontology including a plurality of mapping constructs, including an input device for receiving (i) a quantity of distinct asset constructs, denoted by C_{ASSET}, (ii) a quantity of distinct mapping constructs, denoted by C_{MAPPING}, and (iii) a quantity of distinct model constructs, denoted by C_{MODEL}, a processor coupled to the input device for evaluating a metric of complexity, denoted by M, for an enterprise information resource management system with capacity corresponding to C_{ASSET}, C_{MAPPING} and C_{MODEL}, according to a formula
M=ƒ(C_{ASSET}, C_{MAPPING}, C_{MODEL}, X),
where ƒ is a real-valued function of three or more real-valued parameters and X denotes optional additional parameters, and a transaction processing system receiving the metric M for licensing the enterprise information resource management system.

There is yet further provided in accordance with a preferred embodiment of the present invention a system for determining complexity of a metadata repository including a plurality of metadata constructs, including an input device for receiving a quantity of distinct metadata constructs, denoted by C, a processor coupled to the input device for evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters, and a transaction processing system using the metric M for licensing the metadata repository.

There is moreover provided in accordance with a preferred embodiment of the present invention a system for determining complexity of a metadata repository including a plurality of metadata constructs, the metadata constructs being instances of meta-model constructs for meta-models of schemas for data assets, including an input device for receiving a quantity of distinct meta-model constructs, denoted by C, a processor coupled to the input device for evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters, and a transaction system receiving the metric M, for license of the metadata repository.

There is additionally provided in accordance with a preferred embodiment of the present invention a computer-readable storage medium storing program code for causing a computer to determine complexity of an enterprise information resource management system, the enterprise information resource management system being used to contain an ontology into which a plurality of enterprise data assets are mapped, the ontology including a plurality of model constructs, the enterprise data assets including a plurality of assets constructs, and the mappings between the data assets and the ontology including a plurality of mapping constructs, by performing the steps of determining (i) a quantity of distinct asset constructs, denoted by C_{ASSET}, (ii) a quantity of distinct mapping constructs, denoted by C_{MAPPING}, and (iii) a quantity of distinct model constructs, denoted by C_{MODEL}, evaluating a metric of complexity, denoted by M, for an enterprise information resource management system having a capacity corresponding to C_{ASSET}, C_{MAPPING} and C_{MODEL}, according to a formula
M=ƒ(C_{ASSET}, C_{MAPPING}, C_{MODEL}, X),
where ƒ is a real-valued function of three or more real-valued parameters and X denotes optional additional parameters, and using the metric M within a transaction processing system, for license of the enterprise information resource management system.

There is further provided in accordance with a preferred embodiment of the present invention a computer-readable storage medium storing program code for causing a computer to determine complexity of a metadata repository including a plurality of metadata constructs, by performing the steps of determining a quantity of distinct metadata constructs, denoted by C, evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters, and using the metric M within a transaction processing system, for license of the metadata repository.

There is yet further provided in accordance with a preferred embodiment of the present invention computer-readable storage medium storing program code for causing a computer to determine complexity of a metadata repository including a plurality of metadata constructs, the metadata constructs being instances of meta-model constructs for meta-models of schemas for data assets, by performing the steps of determining a quantity of distinct meta-model constructs, denoted by C, evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters, and using the metric M within a transaction processing system, for license of the metadata repository.

### BRIEF DESCRIPTION OF THE DRAWINGS

The present invention will be more fully understood and appreciated from the following detailed description, taken in conjunction with the drawings in which:

FIG. 1 is a sample screen shot showing quantities of counts of constructs within a model of an enterprise resource management system, in accordance with a preferred embodiment of the present invention;

FIG. 2 is a simplified tabular illustration of a pricing formula for enterprise information resource management systems, in accordance with a preferred embodiment of the present invention;

FIG. 3 is a simplified Object Management Group (OMG) Meta-Object Facility (MOF) diagram of a simple meta-model for relational database schemas, in accordance with a preferred embodiment of the present invention;

FIG. 4 is a simplified flowchart of a method for determining a metric of complexity for an enterprise information resource management system, in accordance with a preferred embodiment of the present invention; and

FIG. 5 is a simplified block diagram of a system for determining a metric of complexity for an enterprise information resource management system, in accordance with a preferred embodiment of the present invention.

### DETAILED DESCRIPTION OF A PREFERRED EMBODIMENT

The present invention provides a novel pricing formula for enterprise information resource management systems, based on a “measure of complexity” of a business' data. The present invention recognizes that data complexity cannot accurately be measured by the size of a business, such as the size of its intranet or the number of its employees. A business' financial indicators, such as its annual revenue, also cannot accurately measure data complexity. Clearly such metrics cannot distinguish between businesses that are data intensive and those that are not.

In fact, neither is the amount of data stored by a business a good indicator of data complexity, since a business such as a food or clothing manufacturer may archive massive amounts of data within a few very simple tables, and conversely a business with specialized customized financial products such as a reinsurer may archive small amounts of data within very complex data structures.

The present invention measures the data complexity of a business in terms of the number of constructs required to represent the business' data assets and map them into an appropriate central ontology model. The amount of data actually stored within each data asset is generally irrelevant. What matters is the structure of the data assets; i.e., their schemas, and the inter-relationships between them.

Applicant's systems and methodologies for representing data assets, for generating a central ontology model into which the data assets can be mapped and for generating such mappings, are described in applicant's co-pending patent applications:
U.S. Ser. No. 09/866,101 filed on May 25, 2001 and entitled METHOD AND SYSTEM FOR COLLABORATIVE ONTOLOGY MODELING;
U.S. Ser. No. 09/904,457 filed on Jul. 6, 2001 and entitled INSTANCE BROWSER FOR ONTOLOGY;
U.S. Ser. No. 10/053,045 filed on Jan. 15, 2002 and entitled METHOD AND SYSTEM FOR DERIVING A TRANSFORMATION BY REFERRING SCHEMA TO A CENTRAL MODEL;
U.S. Ser. No. 10/104,785 filed on Mar. 22, 2002 and entitled RUN-TIME ARCHITECTURE FOR ENTERPRISE INTEGRATION WITH TRANSFORMATION GENERATION;
U.S. Ser. No. 10/159,516 filed on May 31, 2002 and entitled DATA QUERY AND LOCATION THROUGH A CENTRAL ONTOLOGY MODEL;
U.S. Ser. No. 10/302,370 filed on Nov. 22, 2002 and entitled ENTERPRISE INFORMATION UNIFICATION;
U.S. Ser. No. 10/340,068 filed on Jan. 9, 2003 and entitled BROKERING SEMANTICS BETWEEN WEB SERVICES;
U.S. Ser. No. 10/637,171 filed on Aug. 7, 2003 and entitled WEB CLIENT FOR VIEWING AND INTERROGATING ENTERPRISE DATA SEMANTICALLY; and
U.S. Ser. No. 10/637,339 filed on Aug. 8, 2003 and entitled METHOD AND SYSTEM FOR MAPPING ENTERPRISE DATA ASSETS TO A SEMANTIC INFORMATION MODEL.

As described in the above referenced patent applications, enterprise data is typically distributed over multiple databases, message formats and archives, referred to collectively as “data assets”. Data assets can be of various technologies, including inter alia relational databases, XML documents and databases, object databases, flat files and Cobol copybooks. Logical models may also comprise assets such as entity-relationship diagrams (ERD), object diagrams such as Unified Modeling Language (UML) diagrams, object role models, topic maps and process models. Each data asset stores data according to a specific data structure format, referred to as a “schema”. The schema provides a template for storing data in the asset and for interpreting that data. Without knowledge of the schema, data stored within the asset is generally unintelligible. Thus, for example, relational database tables store data according to a relational database schema comprising tables, columns and foreign keys, XML documents store data according to an XML schema describing named complex types and elements, and Cobol copybooks store data according to a Cobol Copybook Definition. Each such schema is effectively asset metadata, which explains how to interpret data stored within the asset. Some assets such as flat files do not have a formal schema but instead have documentation, which is an informal way of establishing the schema. Assets may also have metadata in addition to their schemas, including inter alia the name of an administrator, a description and a location.

Asset metadata is generally authored by one or more people serving as developers or data administrators and, when collected into a metadata repository or an enterprise information resource management system, the metadata is preferably stored within one or more “packages”. A package is a collection of metadata for one or more data assets, similar to the package used in Java to store one or more Java classes. Breakdown of asset metadata into packages is arbitrary, although it is customary that packages have a common theme, such as a department, a physical data center or a technology such as XML. Packages themselves may be broken down into sub-packages. For example, a package for sales metadata may include sub-packages of metadata for government sales, military sales, and foreign country sales, and each sub-package may be authored by a different person.

Asset metadata is typically comprised of basic data structures, or “constructs”. For example, relational database schemata are comprised of tables and columns, XML schema are comprised of simple types and complex types, elements and attributes, ER logical models are comprised of entities and relationships, and Cobol Copybooks are comprised of elementary items and group items.

More generally, asset metadata often includes two types of constructs: a simple construct, referred to as an “element” or alternatively as an “atom”, and a complex construct which groups elements, referred to as a “element group” or alternatively as a “composite”, which is used to organize multiple elements. For example, the elements within a relational database schema are individual fields, or table columns, and the element groups are tables. Similarly, the elements within an XML schema are simple types, and the element groups are complex types.

In a preferred embodiment of the present invention, semantics are provided to enterprise data through (i) a global ontology model, referred to simply as an “ontology”; and (ii) mappings of enterprise asset metadata into the ontology. An ontology is comprised of classes, which correspond to the element group constructs, and properties, which correspond to the element constructs, and is particularly useful for representing data in a semantically meaningful way. Mappings are associations of constructs of a first asset metadata with constructs of a second asset metadata, and generally identify elements with elements and element groups with element groups in a consistent way. Mappings of asset metadata into an ontology serve as dictionaries through which constructs of the asset metadata can be semantically understood.

Altogether, packages, asset metadata, the ontology and the mappings are part of a unified enterprise information archive referred to herein as a “project”.

In accordance with a preferred embodiment of the present invention, the complexity of an enterprise information resource management system is measured by the number of constructs required (i) to represent the enterprise data assets; (ii) to generate the ontology; and (iii) to represent the mappings between the data assets and the ontology. Specifically, if the above numbers of constructs are denoted by variables C_{ASSET}, C_{MODEL}, and C_{MAPPING}, respectively, then the complexity of an enterprise information resource management system is measured as a function of these three variables. Correspondingly, an enterprise information resource management system is priced according to the formula
P=ƒ(C_{ASSET}, C_{MAPPING}, C_{MODEL}, X), (1)
where P denotes the price of the system, ƒ denotes a real-valued function of at least three parameters, and X denotes optional additional parameters. For example, X may include inter alia:
(i) a number of packages within a project;
(ii) a parameters for a number of available features included with the system;
(iii) a parameter for an edition of the system, say, standard edition and enterprise edition with different feature sets;
(iv) a parameter for the term of a license, say, a one-year or two-year license;
(v) a parameter for non-recurrent engineering work such as installation;
(vi) a parameter for maintenance and technical support; and
(vii) a parameter for a number of users of the system.

In addition, pricing formula (1) may also include dependencies on other constructs, such as business rules that inter-relate properties of the ontology, and metadata for describing the data assets, the ontology and the mappings. Optionally the construct counts for pricing purposes may either include or exclude (i) archived and obsolete versions of metadata; (ii) libraries such as industry standard ontologies and schemas; and (iii) test instance data.

In accordance with a preferred embodiment of the present invention, the enterprise information resource management system is used to automatically generate code, such as SQL queries and XSLT scripts, for data query and translation, and reports about the enterprise data assets, as described in detail in the above referenced US patent applications. Accordingly, pricing formula (1) may also include dependencies on the number of results generates and saved, and on the number of different types of reports generated and saved.

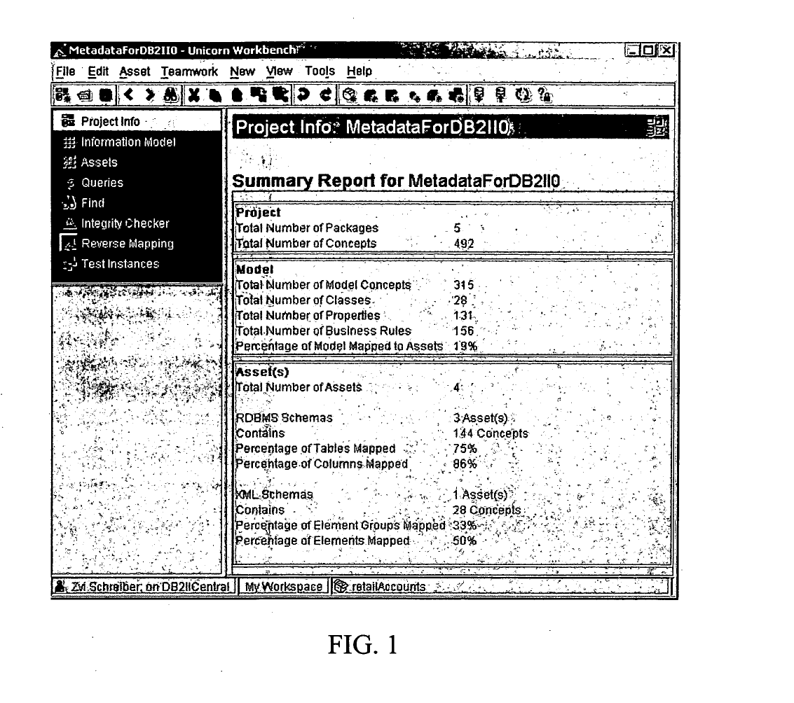

Reference is now made to FIG. 1, which is a sample screen shot showing quantities of counts of constructs within a model of an enterprise resource management system, in accordance with a preferred embodiment of the present invention. As seen in FIG. 1, a model for a database named DB2110 includes 492 constructs (referred to as “concepts” within FIG. 1), as follows:
5 packages;
315 model constructs for an ontology model; namely,
28 classes, 131 properties and 156 business rules;
144 relational database constructs; and
28 XML constructs.

In accordance with a preferred embodiment of the present invention, these quantities are used to determine a metric of complexity of an enterprise system, instead of conventional parameters such as the amount of data stored within the relational databases and XML schemas. Thus, referring again to FIG. 1, the 3 relational database schemas and the 1 XML schema may hold any volume of data without impacting the complexity of the enterprise system. Irrespective of the volume of data stored, the complexity of the enterprise system is based on it having 3 relational database schemas having a total of 144 constructs (tables and columns), 1 XML schema having a total of 28 constructs (simple and complex elements), and the inter-relationships between these constructs as determined by the number of classes and properties within the ontology model. The sheer volume of data stored therewithin or the number of computer processors used to manage the enterprise system preferably do not impact the complexity of the enterprise system.

It may be appreciated by those skilled in the art that inter-relationships such as foreign keys within relational database tables preferably show up as properties within the ontology model. Thus, the quantity of model constructs is a measure of inter-relationships within data asset constructs.

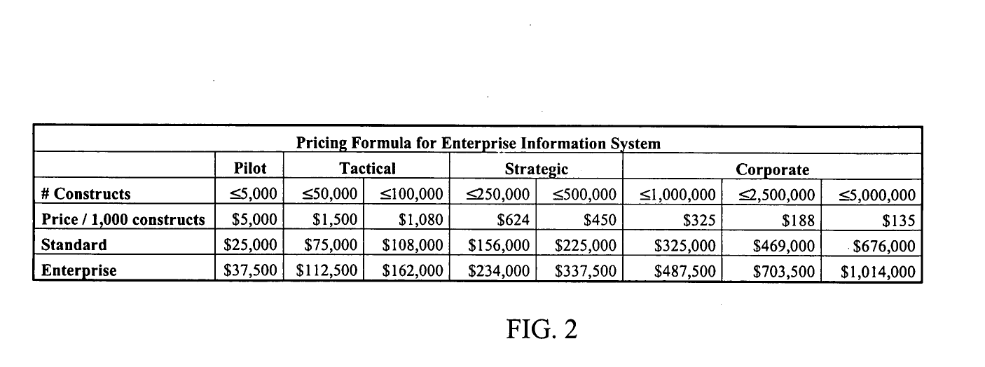

Reference is now made to FIG. 2, which is a simplified tabular illustration of a pricing formula for enterprise information resource management systems, in accordance with a preferred embodiment of the present invention. The table of FIG. 1 includes a row labeled “# Constructs”, which indicates the maximum capacity; i.e., the maximum number of total metadata constructs permitted simultaneously for the system, namely C_{ASSET}+C_{MAPPING}+C_{MODEL}. The row labeled “Price/1,000 Constructs” indicates the unit price per 1,000 permitted constructs. The row labeled “Standard” indicates the total price for the system corresponding to each capacity. Thus, for example, a system with maximum capacity of 5,000 simultaneous constructs is priced at $5,000 per 1,000 constructs, yielding a total price of $5,000×5=$25,000. Similarly, a system with maximum capacity of 50,000 simultaneous constructs is priced at $1,500 per 1,000 constructs, yielding a total price of $1,500×50=$75,000. Roughly, when the maximum capacity goes up by a factor of 10, the unit price per 1,000 constructs goes down by a factor of 3. The row labeled “Enterprise”indicates pricing for an enhanced system, which has more features and functionality than a standard system. As can be seen in the table, the enterprise system is priced 50% higher than the standard system.

It may be appreciated that the table in FIG. 2 corresponds to a pricing formula (1) that takes the special form of a step function
ƒ(C_{ASSET}, C_{MAPPING}, C_{MODEL}, X)=ƒₙ(X), iƒCₙ₋₁<C≦Cₙ, (2)
where C is the total number of constructs, C=C_{ASSET}+C_{MAPPING}+C_{MODEL}, and C₀, C₁, C₂, . . . are cutoff points for pricing. Specifically, the cutoff points in the table shown in FIG. 1 are C₀=0; C₁=5,000; C₂=50,000; C₃=100,000; C₄=250,000; C₅=500,000; C₆=1,000,000; C₇=2,500,000; and C₈=5,000,000. The parameter X corresponds to the standard or enterprise edition, with X=1 for the standard edition, and X=1.5 for the enterprise edition. The functions ƒₙ(X) are given by
ƒₙ(X)=UₙCₙX, (3)
where Uₙ is the unit price per construct within the n^{th} pricing bin; namely, U₁=$5.00; U₂=$1.50; U₃=$1.08; U₄=$0.624; U₅=$0.45; U₆=$0.325; U₇=$0.188; and U₈=$0.135.

It may be appreciated by those skilled in the art that pricing formula (2) may be implemented automatically within a spreadsheet that contains an array, designated as C_ARRAY, for the cutoff points Cₙ, and arrays, designated as F_ARRAY_X, for the functions ƒₙ(X), for possible values of X. Thus, within Microsoft Excel, if the value of C is entered into a cell, designated as CELL_C, then the corresponding price P for a system corresponding to parameter X, can be determined by the worksheet functions
CELL_TMP=MATCH(CELL, C_ARRAY, −1);
CELL_P=INDEX(F_ARRAY_X, 1, CELL_TMP).
   The value of P is automatically generated within cell CELL_P, based on the value of C entered into cell CELL_C.

In accordance with a preferred embodiment of the present invention, an enterprise system priced according to the table in FIG. 2 is designed in such a way that the maximum number of permitted constructs paid for is automatically enforced by the system. Preferably, the maximum number of permitted constructs is encoded within a license key. It may be appreciated that use of a license key to encode the maximum number of permitted constructs provides a simple mechanism for updating an enterprise system to allow a higher maximum number of permitted constructs; namely, by issuing a replacement license key having a higher maximum number of permitted constructs encoded therein.

It may be appreciated by those skilled in the art that the general pricing formula (1) includes a wide variety specific pricing formulas such as pricing formula (2). For example, the parameter C in formula (2) may be a weighted combination of C_{ASSET}, C_{MAPPING} and C_{MODEL}, instead of a straight sum; i.e., C=W_{ASSET} C_{ASSET}+W_{MAPPING} C_{MAPPING}+W_{MODEL} C_{MODEL}, where W_{ASSET}, W_{MAPPING} and W_{MODEL} are respective weighting factors.

In accordance with a preferred embodiment of the present invention, the enterprise information resource management system has a meta-model for defining schemas of metadata that the system can store. For example, a meta-model can define a schema that includes tables and columns, for structuring enterprise data as relational database tables; or a schema that includes simple elements and complex elements, for structuring enterprise data as XML documents. Such a meta-model is effectively a schema for a data asset schema. Preferably such a meta-model is configurable at runtime in accordance with a standard, such as the Object Management Group (OMG) Meta-Object Facility (MOF) standard.

Within the setting of a given meta-model, and in accordance with a preferred embodiment of the present invention, a pricing formula takes the general form
P=ƒ(M, X), (4)
where P is the price of the system, ƒ is a real-valued function of one or more real-valued parameters, M denotes the number of distinct meta-model constructs, and X denotes optional additional parameters.

It may be appreciated that the number, M, of constructs in the meta-model serves as a measure of complexity relating to the number of different types of IT assets in the enterprise. Thus counting meta-model constructs corresponds to counting how many different types of assets the enterprise has, rather than the number and complexity of the actual assets.

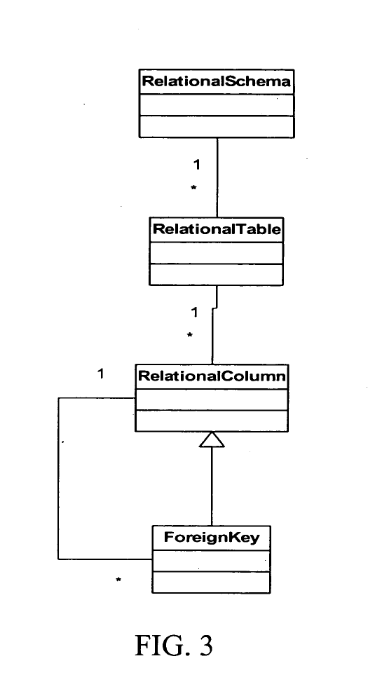

In this regard, reference is now made to FIG. 3, which is a simplified Object Management Group (OMG) Meta-Object Facility (MOF) diagram of a simple meta-model for relational database schemas, in accordance with a preferred embodiment of the present invention. Given such a meta-model, each instance of a meta-model class will be a metadata construct that is counted for determining price. Preferably, a meta-model is defined for the ontology and for mappings between schemas and the ontology, so that the counts,. C_{ASSET}, C_{MAPPING}, C_{MODEL} in pricing formula (1) are special cases of counting metadata instances of meta-model classes.

Optionally, metadata instances of relationships and attributes in the meta-model may also be counted. For example, attributes in a meta-model include descriptors for data assets such as a description, a name of an administrator and a location. Optionally, instances of certain specific meta-model classes may be exempted from counting for pricing purposes. For example, a meta-model may include a class whose instances are not considered to contribute to the complexity of an enterprise; or, e.g., a vendor may choose to charge for relational database columns but not for tables, which are simply groupings of the columns.

The present invention is preferably implemented in software or hardware, or as a software/hardware combination. It may be implemented within a spreadsheet application, such as Microsoft Excel, as described above regarding FIG. 2, or within a standalone application, or as a web service.

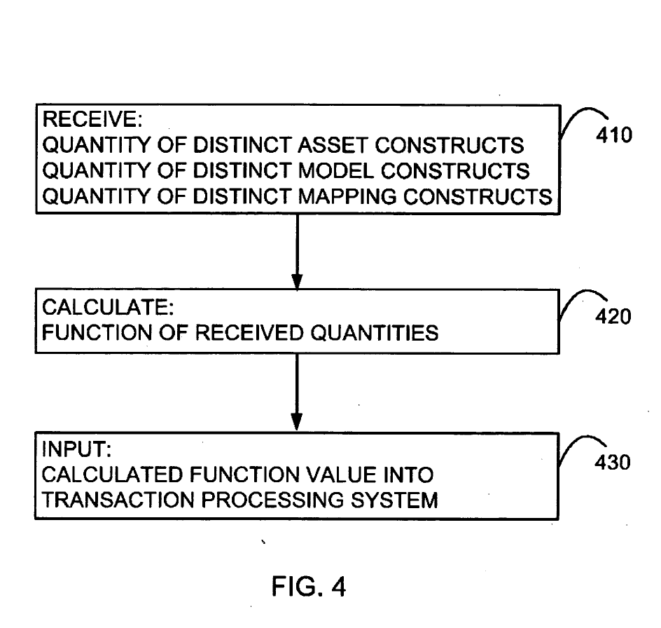

In this regard, reference is now made to FIG. 4, which is a simplified flowchart of a method for determining a metric of complexity for an enterprise information resource management system, in accordance with a preferred embodiment of the present invention. As shown in FIG. 4, at step 410 quantities of constructs, denoted hereinabove by C_{ASSET}, C_{MODEL} and C_{MAPPING} are received. At step 420 a function of the received quantities is evaluated, and at step 430 the function value is used within a transaction processing system, such as a purchasing or billing or accounting system.

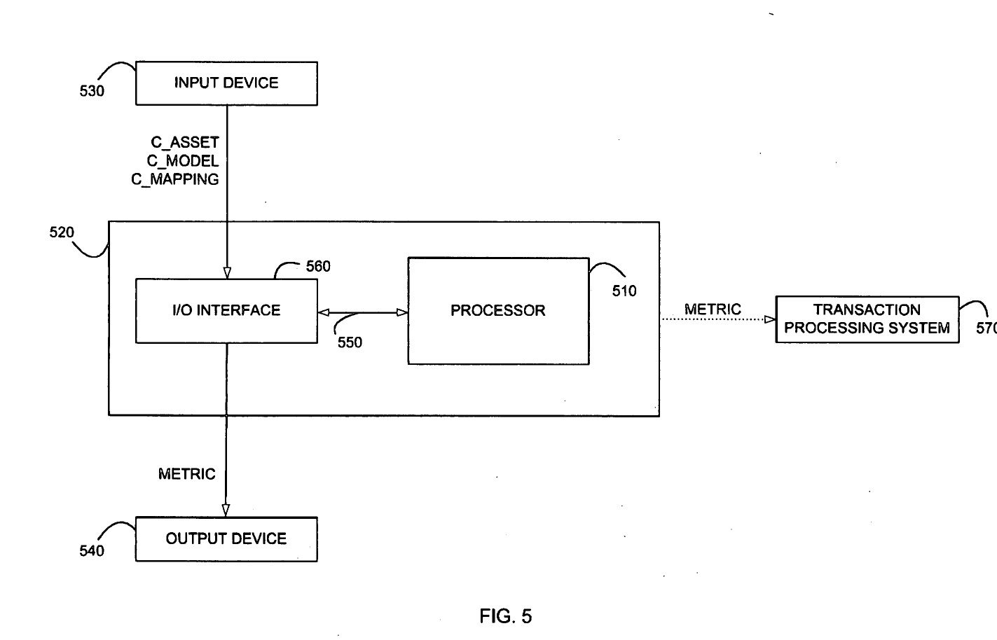

Reference is now made to FIG. 5, which is a simplified block diagram of a system for determining a metric of complexity for an enterprise information resource management system, in accordance with a preferred embodiment of the present invention. As shown in FIG. 5, a processor 510 within a computer 520 is coupled to an input device 530, such as a keyboard, and an output device 540, such as a computer monitor, typically by a computer data bus 550 with one or more I/O interfaces 560. Data bus 550 typically couples other components as well (not shown) to processor 510, including inter alia an internal memory manager, a file system manager, a network interface, one or more disk drives, and one or more USB devices. Processor 510 receives quantities C_{ASSET}, C_{MODEL} and C_{MAPPING} from input device 530, and computes a metric, which is displayed on output device 540.

Preferably, the computed metric is used as input to a transaction processing system 570, such as a corporate accounting, billing or purchasing system, for completing a licensing transaction for the enterprise information resource management system. Preferably, the metric is used for determining the price of the license. The link between processor 510 and transaction processing system 570 is dashed, to indicate that the transfer of data therebetween may be either automatic or manual, and either direct or indirect.

In reading the above description, persons skilled in the art will appreciate that there are many apparent variations that can be applied to the methods and systems described.

In one variation, metadata constructs may correspond to metadata objects, in an object-oriented sense. Specifically, within the Meta-Object Facility (MOF), metadata corresponds to objects that are instances of MOF classes in a normal object-oriented paradigm.

In another variation, metadata need not be limited to data assets, and may also include metadata for other IT resources such as business process models, network topographies, employee roles and applications. Preferably, such metadata for other IT resources is not mapped into an ontology.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1. A method for determining complexity of an enterprise information resource management system, the enterprise information resource management system being used to contain an ontology into which a plurality of enterprise data assets are mapped, the ontology including a plurality of model constructs, the enterprise data assets including a plurality of assets constructs, and the mappings between the data assets and the ontology including a plurality of mapping constructs, comprising:
receiving (i) a quantity of distinct asset constructs, denoted by C_{ASSET}, (ii) a quantity of distinct mapping constructs, denoted by C_{MAPPING}, and (iii) a quantity of distinct model constructs, denoted by C_{MODEL};
evaluating a metric of complexity, denoted by M, for an enterprise information resource management system having a capacity corresponding to C_{ASSET}, C_{MAPPING} and C_{MODEL}, according to a formula
M=ƒ(C_{ASSET}, C_{MAPPING}, C_{MODEL}, X),
where ƒ is a real-valued function of three or more real-valued parameters and X denotes optional additional parameters; and
using the metric M within a transaction processing system, for license of the enterprise information resource management system.

2. The method of claim 1 wherein the plurality of data assets include assets that conform to a general data schema that uses element group asset constructs and element asset constructs.

3. The method of claim 2 wherein the general data schema is a relational database schema, and the element group asset constructs are database tables and the element asset constructs are columns of database tables.

4. The method of claim 2 wherein the general data schema is an XML schema, and the element group asset constructs are XML complex types and the element asset constructs are XML elements.

5. The method of claim 2 wherein the general data schema is a Cobol Copy Book, and the element group asset constructs are Cobol group items and the element asset constructs are Cobol elementary items.

6. The method of claim 2 wherein the ontology is an ontology model, and wherein the model constructs include ontology classes and their properties, and business rules that inter-relate the properties.

7. The method of claim 6 wherein the mapping constructs include mappings of element group asset constructs into ontology classes and mapping of element asset constructs into ontology properties.

8. The method of claim 6 wherein the function ƒ(C_{ASSET}, C_{MAPPING}, C_{MODEL}, X) is a step function of the form
ƒ(C_{ASSET}, C_{MAPPING}, C_{MODEL}, X)=ƒₙ(X), iƒCₙ₋₁<C≦Cₙ,
where C is the total number of constructs, C=C_{ASSET}+C_{MAPPING}+C_{MODEL}, and where C₀, C₁, C₂, . . . are cutoff points.

9. The method of claim 6 wherein the function ƒ(C_{ASSET}, C_{MAPPING}, C_{MODEL}, X) is a step function of the form
ƒ(C_{ASSET}, C_{MAPPING}, C_{MODEL}, X)=ƒₙ(X), iƒCₙ₋₁<C≦Cₙ,
where C is a weighted average C=W_{ASSET} C_{ASSET}+W_{MAPPING} C_{MAPPING}+W_{MODEL} C_{MODEL}, and where W_{ASSET}, W_{MAPPING} and W_{MODEL} are respective weighting factors, and where C₀, C₁, C₂, . . . are cutoff points.

10. The method of claim 1 wherein the enterprise information resource management system generates results for tasks, and wherein the metric M also depends on the number of distinct results generated and saved.

11. The method of claim 10 wherein the results include data transformations.

12. The method of claim 10 wherein the results include SQL queries.

13. The method of claim 10 wherein the results include XSLT scripts.

14. The method of claim 1 wherein the enterprise information resource management system generates scripts for producing reports, and wherein the metric M also depends on the number of distinct report scripts generated and saved.

15. The method of claim 1 wherein the enterprise information resource management system records metadata, and wherein the metric M also depends on the number of distinct metadata records.

16. A method for determining complexity of a metadata repository including a plurality of metadata constructs, comprising:
receiving a quantity of distinct metadata constructs, denoted by C;
evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters; and
using the metric M within a transaction processing system, for license of the metadata repository.

17. The method of claim 16 wherein metadata constructs are instances of meta-model constructs.

18. The method of claim 17 wherein the meta-data constructs are constructs for meta-models of asset schemas, and wherein the price P also depends on the number of meta-model constructs.

19. The method of claim 17 wherein at least one meta-model is a schema for relational database schemas, and wherein at least one metadata construct corresponds to a table of a relational database schema.

20. The method of claim 17 wherein at least one meta-model is a schema for XML schemas, and wherein at least one metadata construct corresponds to a complex element of an XML schema.

21. A method for determining complexity of a metadata repository including a plurality of metadata constructs, the metadata constructs being instances of meta-model constructs for meta-models of schemas for data assets, comprising:
receiving a quantity of distinct meta-model constructs, denoted by C;
evaluating a metric of complexity, denoted by M, for a metadata repository having a capacity corresponding to C, according to a formula
M32 ƒ(C, X),
where ƒ is a real-valued function of one or more real-valued parameters and X denotes optional additional parameters; and
using the metric M within a transaction processing system, for license of the metadata repository.

22. The method of claim 21 wherein at least one meta-model is a schema for relational database schemas, and wherein at least one metadata construct corresponds to a table of a relational database schema.

23. The method of claim 21 wherein at least one meta-model is a schema for XML schemas, and wherein at least one metadata construct corresponds to a complex element of an XML schema.

24. The method of claim 21 wherein the meta-model constructs include descriptors for data assets.

25. The method of claim 21 wherein the optional additional parameters include a parameter for a number of users of the repository.

26. The method of claim 21 wherein the optional additional parameters include a parameter for a number of available features.

27. The method of claim 26 wherein an available feature is the ability to change a meta-model.

28. The method of claim 26 wherein an available feature is the ability to batch scan metadata.

29. A system for determining complexity of an enterprise information resource management system, the enterprise information resource management system being used to contain an ontology into which a plurality of enterprise data assets are mapped, the ontology including a plurality of model constructs, the enterprise data assets including a plurality of assets constructs, and the mappings between the data assets and the ontology including a plurality of mapping constructs, comprising:
an input device for receiving (i) a quantity of distinct asset constructs, denoted by C_{ASSET}, (ii) a quantity of distinct mapping constructs, denoted by C_{MAPPING}, and (iii) a quantity of distinct model constructs, denoted by C_{MODEL};
a processor coupled to said input device for evaluating a metric of complexity, denoted by M, for an enterprise information resource management system with capacity corresponding to C_{ASSET}, C_{MAPPING} and C_{MODEL}, according to a formula
M=ƒ(C_{ASSET}, C_{MAPPING}, C_{MODEL}, X),
where ƒ is a real-valued function of three or more real-valued parameters and X denotes optional additional parameters; and
a transaction processing system receiving the metric M for licensing the enterprise information resource management system.

30. The system of claim 29 wherein the plurality of data assets include assets that conform to a general data schema that uses element group asset constructs and element asset constructs.

31. The system of claim 30 wherein the general data schema is a relational database schema, and the element group asset constructs are database tables and the element asset constructs are columns of database tables.

32. The system of claim 30 wherein the general data schema is an XML schema, and the element group asset constructs are XML complex types and the element asset constructs are XML elements.

33. The system of claim 30 wherein the general data schema is a Cobol Copy Book, and the element group asset constructs are Cobol group items and the element asset constructs are Cobol elementary items.

34. The system of claim 30 wherein the ontology is an ontology model, and wherein the model constructs include ontology classes and their properties, and business rules that inter-relate the properties.

35. The system of claim 34 wherein the mapping constructs include mappings of element group asset constructs into ontology classes and mapping of element asset constructs into ontology properties.

36. The system of claim 34 wherein the function ƒ(C_{ASSET}, C_{MAPPING}, C_{MODEL}, X) is a step function of the form
ƒ(C_{ASSET}, C_{MAPPING}, C_{MODEL}, X)=ƒₙ(X), iƒCₙ₋₁<C≦Cₙ,
where C is the total number of constructs, C=C_{ASSET}+C_{MAPPING}+C_{MODEL}, and where C₀, C₁, C₂, . . . are cutoff points.

37. The system of claim 34 wherein the function ƒ(C_{ASSET}, C_{MAPPING}, C_{MODEL}, X) is a step function of the form
ƒ(C_{ASSET}, C_{MAPPING}, C_{MODEL}, X)=ƒₙ(X), iƒCₙ₋₁<C≦Cₙ,
where C is a weighted average C=W_{ASSET} C_{ASSET}+W_{MAPPING} C_{MAPPING}+W_{MODEL} C_{MODEL}, and where W_{ASSET}, W_{MAPPING} and W_{MODEL} are respective weighting factors, and where C₀, C₁, C₂, . . . are cutoff points.

38. The system of claim 29 wherein the enterprise information resource management system generates results for tasks, and wherein the metric M also depends on the number of distinct results generated and saved.

39. The system of claim 38 wherein the results include data transformations.

40. The system of claim 38 wherein the results include SQL queries.

41. The system of claim 38 wherein the results include XSLT scripts.

42. The system of claim 29 wherein the enterprise information resource management system generates scripts for producing reports, and wherein the metric M also depends on the number of distinct report scripts generated and saved.

43. The system of claim 29 wherein the enterprise information resource management system records metadata, and wherein the metric M also depends on the number of distinct metadata records.

44. A system for determining complexity of a metadata repository including a plurality of metadata constructs, comprising:
an input device for receiving a quantity of distinct metadata constructs, denoted by C;
a processor coupled to said input device for evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters; and
a transaction processing system using the metric M for licensing the metadata repository.

45. The system of claim 44 wherein metadata constructs are instances of meta-model constructs.

46. The system of claim 45 wherein the meta-data constructs are constructs for meta-models of asset schemas, and wherein the price P also depends on the number of meta-model constructs.

47. The system of claim 45 wherein at least one meta-model is a schema for relational database schemas, and wherein at least one metadata construct corresponds to a table of a relational database schema.

48. The system of claim 45 wherein at least one meta-model is a schema for XML schemas, and wherein at least one metadata construct corresponds to a complex element of an XML schema.

49. A system for determining complexity of a metadata repository including a plurality of metadata constructs, the metadata constructs being instances of meta-model constructs for meta-models of schemas for data assets, comprising:
an input device for receiving a quantity of distinct meta-model constructs, denoted by C;
a processor coupled to said input device for evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters; and
a transaction system receiving the metric M, for license of the metadata repository.

50. The system of claim 49 wherein at least one meta-model is a schema for relational database schemas, and wherein at least one metadata construct corresponds to a table of a relational database schema.

51. The system of claim 49 wherein at least one meta-model is a schema for XML schemas, and wherein at least one metadata construct corresponds to a complex element of an XML schema.

52. The system of claim 49 wherein the meta-model constructs include descriptors for data assets.

53. The system of claim 49 wherein the optional additional parameters include a parameter for a number of users of the repository.

54. The system of claim 49 wherein the optional additional parameters include a parameter for a number of available features.

55. The system of claim 54 wherein an available feature is the ability to change a meta-model.

56. The system of claim 54 wherein an available feature is the ability to batch scan metadata.

57. A computer-readable storage medium storing program code for causing a computer to determine complexity of an enterprise information resource management system, the enterprise information resource management system being used to contain an ontology into which a plurality of enterprise data assets are mapped, the ontology including a plurality of model constructs, the enterprise data assets including a plurality of assets constructs, and the mappings between the data assets and the ontology including a plurality of mapping constructs, by performing the steps of:
determining (i) a quantity of distinct asset constructs, denoted by C_{ASSET}, (ii) a quantity of distinct mapping constructs, denoted by C_{MAPPING}, and (iii) a quantity of distinct model constructs, denoted by C_{MODEL};
evaluating a metric of complexity, denoted by M, for an enterprise information resource management system having a capacity corresponding to C_{ASSET}, C_{MAPPING} and C_{MODEL}, according to a formula
M=ƒ(C_{ASSET}, C_{MAPPING}, C_{MODEL}, X),
where ƒ is a real-valued function of three or more real-valued parameters and X denotes optional additional parameters; and
using the metric M within a transaction processing system, for license of the enterprise information resource management system.

58. A computer-readable storage medium storing program code for causing a computer to determine complexity of a metadata repository including a plurality of metadata constructs, by performing the steps of:
determining a quantity of distinct metadata constructs, denoted by C;
evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters; and
using the metric M within a transaction processing system, for license of the metadata repository.

59. A computer-readable storage medium storing program code for causing a computer to determine complexity of a metadata repository including a plurality of metadata constructs, the metadata constructs being instances of meta-model constructs for meta-models of schemas for data assets, by performing the steps of:
determining a quantity of distinct meta-model constructs, denoted by C;
evaluating a metric of complexity, denoted by M, for a metadata repository having a capacity corresponding to C, according to a formula
M=ƒ(C, X),
where ƒ is a real-valued function of one or more real-valued parameters and X denotes optional additional parameters; and
using the metric M within a transaction processing system, for license of the metadata repository.
